(19) United States
(12) Patent Application Publication
(10) Pub. No.: US 2015/0072047 A1
(43) Pub. Date: Mar. 12, 2015

(54) FILLED AND COATED WAFER CONFECTION PRODUCT, METHOD AND MOULD FOR ITS PRODUCTION

(71) Applicant: Mondelez UK R&D Limited, Birmingham (GB)

(72) Inventors: Adam Harris, Birmingham (GB); Oliver Boulton, Birmingham (GB)

(21) Appl. No.: 14/388,204

(22) PCT Filed: May 16, 2013
(86) PCT No.: PCT/GB2013/051256

§ 371 Date: Sep. 25, 2014

(30) Foreign Application Priority Data
May 28, 2012 (GB) 1209452.0

(51) Int. Cl. A23G 3/54; A21C 11/12

(52) U.S. Cl. CPC A23G 3/54; A21C 11/12
USPC 426/76; 425/457

(57) ABSTRACT

The present invention provides a baked product 2, which may be a wafer, comprising a plurality of product sections 6, adjacent product sections 4 mutually separated by a frangible portion 6, said frangible portions 6 including at last one rib 8 extending across at least one of the frangible portions 6 and interconnecting the adjacent product sections 4. The invention further provides a mould for making the products of the invention, and also a method for making them.

The present invention relates to improvements in baked product foodstuffs, including wafers, and apparatus and methods for making the same.

Baked product snacks are often designed to be broken into portions for consumption. To enable ease and regularity of breaking into these portions they typically comprise individual product sections that are connected to one another by a frangible section that will typically have a lesser thickness of material than the product sections. Alternatively, the product sections can have a similar thickness of material as the frangible portions but be deeper overall with a recess in them that can receive a confectionery product, for example a chocolate or cream filing. In this arrangement the confectionery in the recess provides additional strength to the product sections. Thus, in either scenario, when a bending force is applied to the product it will snap across the frangible section having the lesser weakness in preference to snapping across the product section. This enables regular bite sized product sections to be removed and consumed individually.

However, due to the weak nature of baked products, for example wafers, these products often break unintentionally prior to consumption which degrades the consumer experience, such breakage occurring for example during transportation of the packaged products. The products may also break prior to packaging which increases waste and reduces manufacturing efficiency.

The snacks may be coated in one or more layers of confectionery product, for example a chocolate or other confectionery. Although this coating may increase the strength of the bar, as will be appreciated the strength of many confectionery products having a fat content, like for example chocolate, is proportional to its temperature, and also to its thickness. The result of this is that for thin coated products or when products undergo an increase in temperature that reduces the rigidity but does not melt the confectionery, the products are still susceptible to unintentional breakage. Of course, for coated products, any increase in strength due to coating does not reduce any breakage that may occur during manufacture prior to the coating stage.

It is the purpose of the present invention to reduce the incidence of breakage in coated, or uncoated, wafer or baked products, and to provide a method and apparatus for making products of the invention.

According to a first aspect of the invention there is provided a baked product comprising a plurality of product sections, adjacent product sections mutually separated by a frangible portion, at least one said frangible portion including at last one rib extending across it and interconnecting said adjacent product sections. Optionally at least one said ribs may be provided extending across each said frangible portion.

The baked product is generally formed from a dough or batter which is baked to produce the baked product. The baked product may be a cereal-based baked product, and in some embodiments is a wheat-based baked product. In other embodiments the cereal may be maize, corn, oats, rye, rice or barley. In some embodiments the baked product may comprise or potato starch, or other starch-based materials. The baked product may be a wafer, biscuit, pastry, cookie, waffle or any combination thereof.

The frangible portion and/or the product section may have a wall thickness in the range of 1 to 6 mm, or from 1.5 mm to 4.5 mm. This may include the thickness having a being at least 1 mm; at least 1.5 mm; at least 2 mm; at least 2.5 mm; at least 3 mm; or at least 3.5 mm. The thickness may also be no more than 4 mm; no more than 4.5 mm; no more than 5 mm; no more than 5.5 mm; or no more than 6 mm. The frangible portion and the product section may both have different wall thicknesses, at least one of which may be in the ranges described above.

The product sections, the frangible portion and the one or more rib may all comprise the baked product.

The product sections can each have a first height and the or each frangible portion has a second height, less than that of the product sections, thereby forming recesses therebetween. It will be understood that each rib bridges a recess from one product section to an adjacent product section.

In one arrangement the product sections may have recesses in at least one face thereof. The recesses may be at least partially or fully filled with an edible paste or other flowable foodstuff which may be, without limitation: chocolate, toffee, yoghurt, truffle, caramel, liqueurs, syrups, fondant cremes, fruit pastes, pralines, mousses, peanut butter, hazelnut chocolate paste, dairy products such as cheese or cheese flavoured pastes, heat flowable cheeses or cheese products or other confectionery or savoury gels or pastes, or any mixture thereof. In some embodiments the filling is selected from praline, chocolate, truffle, nut chocolate paste, a confectionery emulsion, and combinations thereof. The filling may include particulate material such as nut pieces, fruit pieces, mint flavoured chips, chocolate chips, dried herbs and spices, cereal pieces, confectionery pieces, dried fruit and the like, or mixtures thereof.

The product sections of the baked product of the invention may be substantially rectangular. In other arrangements the product sections may be substantially circular or triangular or any other polyhedral or irregular shape.

Two or more product sections can be arranged to form one of: a linear array; a rectangular array; or a triangular array.

It will be appreciated that the rib(s) may be of any convenient shape. In one embodiment the rib or ribs may be linear and in another embodiment the ribs may have a curved shape. It will be appreciated however that a combination of straight and curved ribs and/or ribs of any other shape, may be used in a single product.

According to a second aspect of the invention there is provided a snack product comprising at least one baked product according to the first aspect of the invention, and a coating comprising at least a first edible substance thereon. The product sections of the baked product may have recesses therein.

In one arrangement the coating may comprise at least a first confectionery material. The at least first confectionery material may comprise a chocolate product, although other confectionery coatings that are solid at room temperature may be used. The term ‘chocolate’ in the context of the present invention and as used throughout this document is not restricted by the various definitions of chocolate provided by government and regulatory bodies. A chocolate is simply a product obtained from cocoa products and sweeteners. The chocolate may be milk chocolate, plain chocolate, white chocolate, sweet chocolate, dark chocolate, or any combination thereof.

The snack product may comprise a further baked product and optionally the product sections of at least one, or both, of the baked products may have recesses therein. The baked product and the further baked product may be joined to one another along their length. In one arrangement the recesses in the product sections of one of the baked products are deeper that the recesses in the product sections of the other baked product, and in another arrangement the recesses in the product sections of both baked products are of the same depth. Where the recesses in the product sections of one of the baked products are deeper that the recesses in the product sections of the other baked product the ribs may be only provided on the baked product having recesses of a lesser depth. Optionally both the baked products may be baked products according to the first aspect of the invention.

In one arrangement the snack product comprises a first and a second baked product according to the first aspect of the invention, each comprising three or more product sections and wherein the ribs of each of the first and second baked product are only provided bridging alternative frangible sections of each said first and second baked, and wherein the ribs on the first and second baked product are offset from one another such that a frangible portion of the first baked product not provided with ribs is positioned overlying a frangible portion of the second baked product having ribs.

The product sections of at least one baked product of the snack product can have recesses in at least one face thereof. A filling which may comprise a second edible substance, which may be a confectionery material, may be provided in one or more recess and may partially or completely fill each recess. The second edible substance may comprise the same material as the first edible substance or may be an alternative. The second edible material may comprise, without limitation: chocolate, toffee, yogurt, truffle, caramel, liqueurs, syrups, fondant cremes, fruit pastes, pralines, mousses, peanut butter, hazelnut chocolate paste, dairy products such as cheese or cheese flavoured pastes, heat flowable cheeses or cheese products or other confectionery or savoury gels or pastes, or any mixture thereof. In some embodiments the filling is a confectionery material selected from praline, chocolate, truffle, nut chocolate paste, a confectionery emulsion, and combinations thereof. The filling may include particulate material such as nut pieces, fruit pieces, mint flavoured chips, chocolate chips, dried herbs and spices, cereal pieces, confectionery pieces, dried fruit and the like, or mixtures thereof.

In some embodiments all of the recesses of one of the baked products are at least partially or fully filled. In other embodiments only some of the recesses of each or both of the baked products are partially or fully filled.

The coating may substantially enclose the whole baked product. The coating may substantially fill the sections of the product adjacent the frangible portions such that substantially no recesses are present between the product sections.

In other embodiments the snack product may comprise two or more coating layers comprising the same or different first edible substances. The outer coating layer may include particulate material embedded or entrained therein, which may comprise chopped nuts and seeds, dried fruit, cereal pieces, chocolate chips, toffee pieces, confectionery pieces, fruit pieces, mint chips, or any combination thereof.

According to a third aspect of the invention there is provided a mould for producing a baked product comprising a plurality of product sections, adjacent product sections mutually separated by a frangible portion, said frangible portions including at last one rib extending across at least one said frangible portion and interconnecting adjacent product sections, the mould comprising: a first mould plate having a substantially planar surface; a plurality of product section recesses in said surface for forming product sections, a first plurality of raised sections located between said product section recesses and extending from the base of the product section recesses towards the planar surface, said first plurality of raised sections for forming said frangible portions; and one or more rib forming recesses in at least one of said first plurality of raised sections; said one or more fib forming recesses for forming said one or more ribs.

In one arrangement said one ore more rib forming recesses may be provided in each of said first plurality of raised sections.

The first plurality of raised portions may terminate below the level of the planar surface of the mould plate.

The rib forming recesses may have a lesser depth than the product section recesses.

The product section recesses may be substantially rectangular, circular or triangular.

In one arrangement the product section recesses may be arranged in a plurality of groups, each forming a linear, rectangular or triangular array of recesses, and the mould may further comprise a second plurality of raised sections surrounding said array. The second plurality of raised sections may be devoid of any recesses.

In one arrangement the mould may further comprise a second mould plate that aligns with said first mould plate to form enclosed mould cavities therebetween. The second mould plate may have raised sections thereon that align with and pass into the product section recesses in the first mould plate.

According to a fourth aspect of the invention there is provided a method of making at least one baked product having a plurality of product sections, adjacent product sections mutually separated by a frangible portion, at least one of said frangible portions including at last one rib extending across said frangible portions and interconnecting said adjacent product sections; the method comprising: providing a mould comprising: a first mould plate having a substantially planar surface; a plurality of product section recesses in said surface for forming product sections, a first plurality of raised sections between said product sections extending from the base of the recesses towards the planar surface, said recesses for forming said frangible portions; and a plurality of rib forming recesses in at least one of said first raised sections; said rib forming recesses for forming said ribs; placing a batter or baked product precursor in said mould; heating said mould to cook said batter or baked product precursor; and removing said baked product from said mould.

The second mould plate may be provided with extensions thereon that align with and protrude into the product recesses of the first mould plate so as to form product sections having recesses therein.

The method may further comprise: providing a second mould plate and, after placing said batter or baked product precursor in said mould, bringing said first and second mould plates together to form a cavity containing said batter or baked product precursor therebetween.

The product section recesses in the first mould plate may be arranged in a plurality of groups and the first mould plate may further comprises a second plurality of raised sections surrounding said groups of product section recesses; and the method may further comprise: after removal of said plurality of baked products from said mould, cutting the baked product along lines formed by said second plurality of raised sections to divide said baked product into a plurality of baked products each comprising a plurality of product sections, adjacent product sections mutually separated by a frangible portion, said frangible portions including at last one rib extending across said frangible portions and interconnecting said adjacent product sections.

According to a fifth aspect of the invention there is provided a method of making a snack product comprising: making at least one baked product comprising a plurality of product sections, adjacent product sections mutually separated by a frangible portion, at least one of said frangible portions including at last one rib extending across said frangible portions and interconnecting said adjacent product sections; and coating said at least one wafer or baked product with a first edible substance. The wafer or baked product may be manufactured according to the forth aspect of the invention.

The method may comprise making a further baked product; and bringing said baked products together in alignment before coating said at least two baked products with a first edible substance as defined in the second aspect of the invention. The first edible substance may comprise a confectionery or savoury material.

The second baked product may also comprise a plurality of product sections, adjacent product sections mutually separated by a frangible portion, at least one of said frangible portions including at last one rib extending across said frangible portions and interconnecting said adjacent product sections.

In one embodiment the step of making at least one of said baked products may comprise making at least one of said baked products having a recess in their product sections; and the method further comprises: after making said baked products and before bringing said baked products together in alignment, filling said recesses in said product sections of said at least one of the baked products with a second edible substance, which may be a confectionery material or a savoury material. The second edible substance may the same as or different from the first edible substance. The second edible substance may be, without limitation chocolate, toffee, yogurt, truffle, caramel, liqueurs, syrups, fondant cremes, fruit pastes, pralines, mousses, peanut butter, hazelnut chocolate paste, dairy products such as cheese or cheese flavoured pastes, heat flowable cheeses or cheese products or other confectionery or savoury gels or pastes, or any mixture thereof. In some embodiments the filling is a confectionery material selected from praline, chocolate, truffle, nut chocolate paste, a confectionery emulsion, and combinations thereof. The filling may include particulate material such as nut pieces, fruit pieces, mint flavoured chips, chocolate chips, dried herbs and spices, cereal pieces, confectionery pieces, dried fruit and the like, or mixtures thereof.

In some embodiments all of the recesses of one of the baked products are at least partially or fully filled, and all of the recesses of both baked products may be partially or fully filled. In other embodiments only some of the recesses of each or both of the baked products are partially or fully filled.

The step of coating said baked product with a first edible substance may comprise coating the baked product with a confectionery or savoury material which, after coating, is solid at room temperature. In one embodiment the first confectionery material may be chocolate.

Coating said at least one baked product with a first edible substance may comprise coating it such that the first edible material substantially fills the frangible portions such that substantially no recesses are present between the product sections.

The invention is now described, without limitation, to the accompanying figures in which:

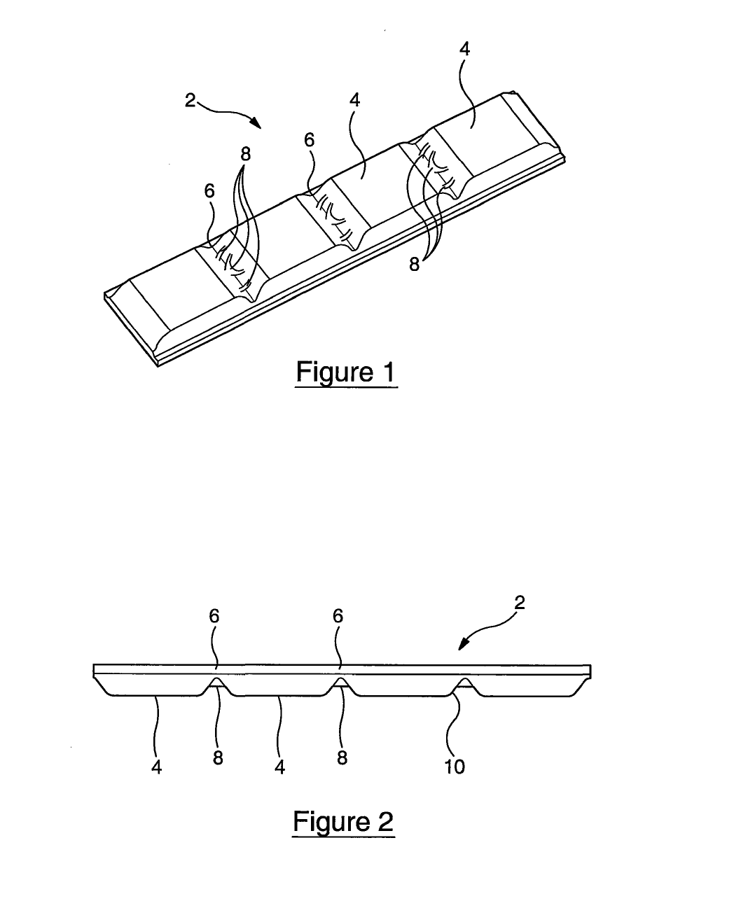

FIG. 1 shows a perspective view of a baked product in accordance with the invention;

FIG. 2 shows a side view of a baked product of FIG. 1;

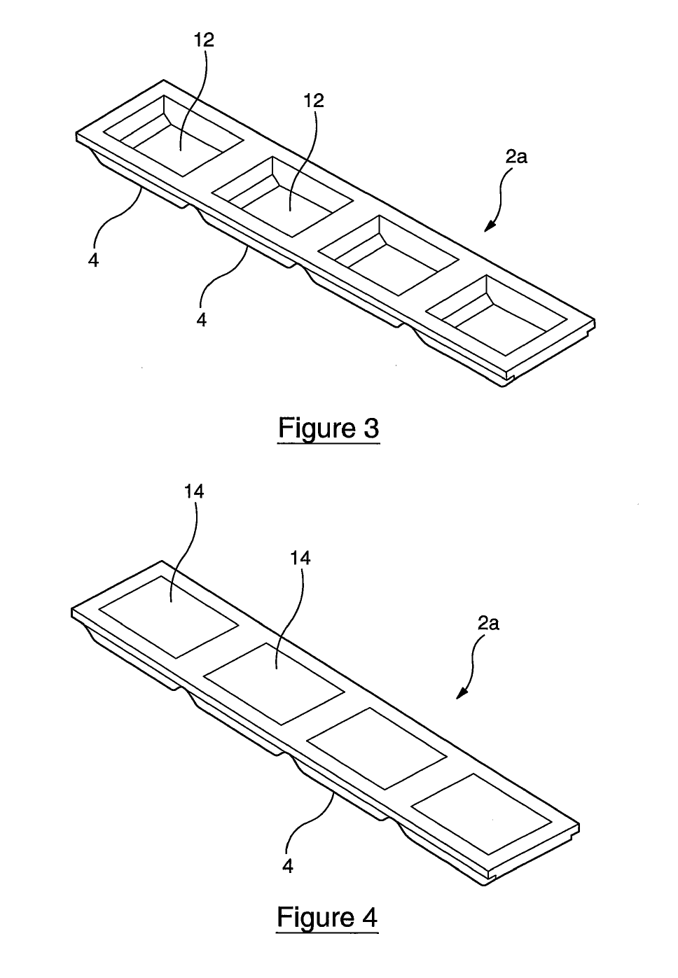

FIG. 3 shows a lower perspective view of a baked product of the invention with recesses;

FIG. 4 shows the baked product of FIG. 3 with the recesses filled with a confectionery product;

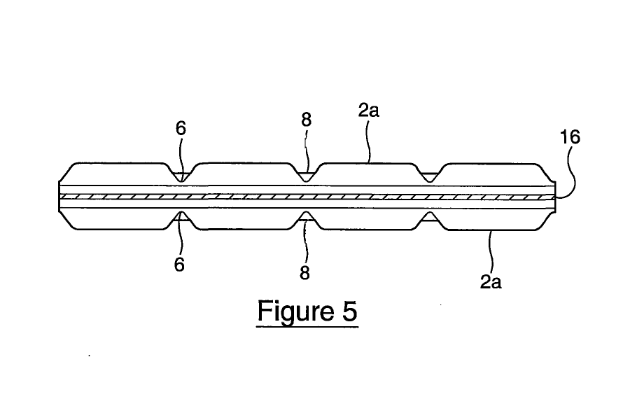

FIG. 5 shows a side view of a baked product in accordance with the invention comprising two wafers sandwiched together;

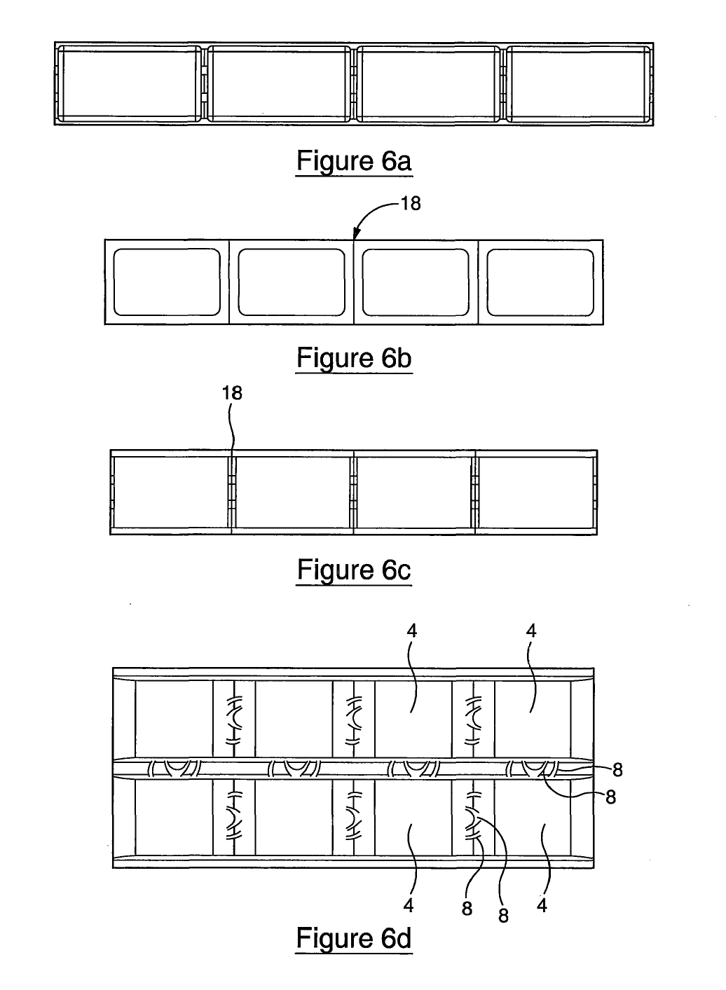

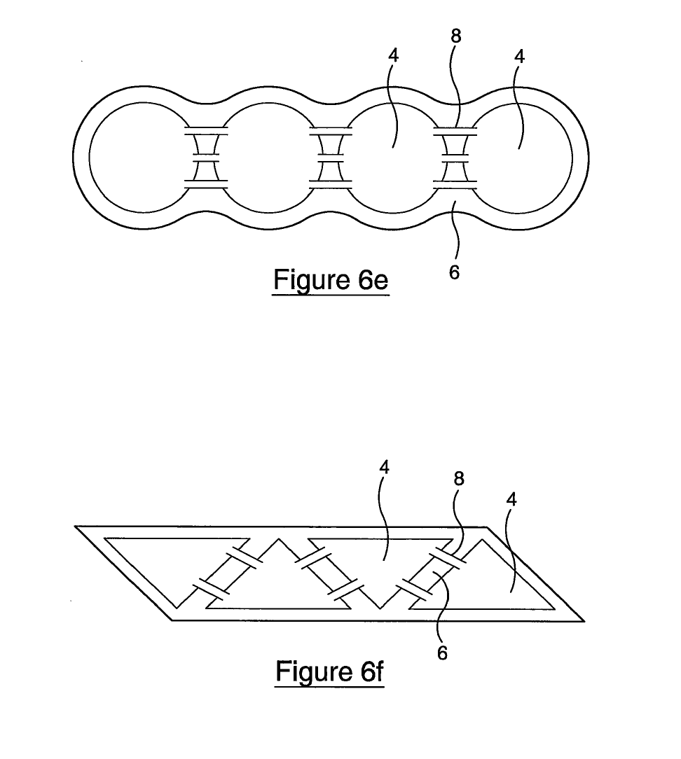

FIGS. 6a to 6f shows alternative configurations of the baked product in accordance with the invention;

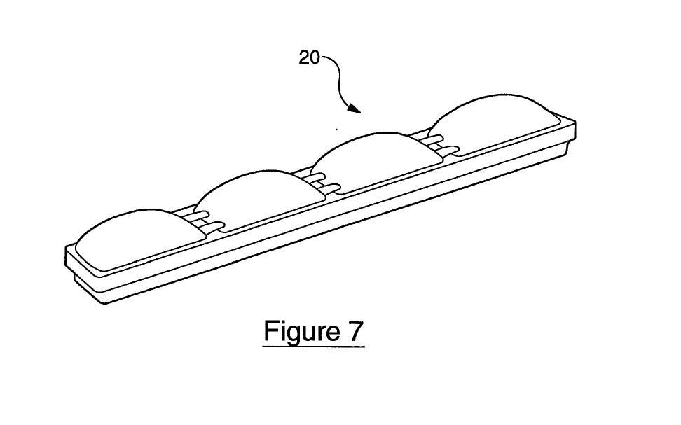

FIG. 7 shows a snack product in accordance with the second aspect of the invention;

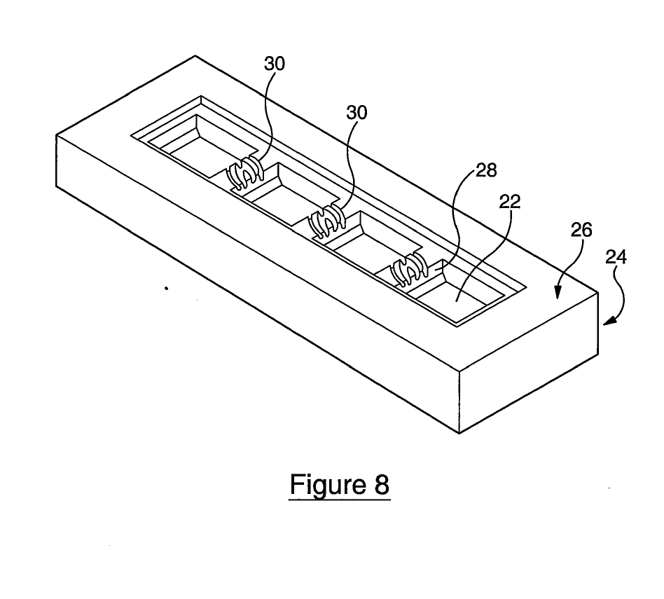

FIG. 8 shows a mould in accordance with the third aspect of the invention for forming the baked product of FIG. 1;

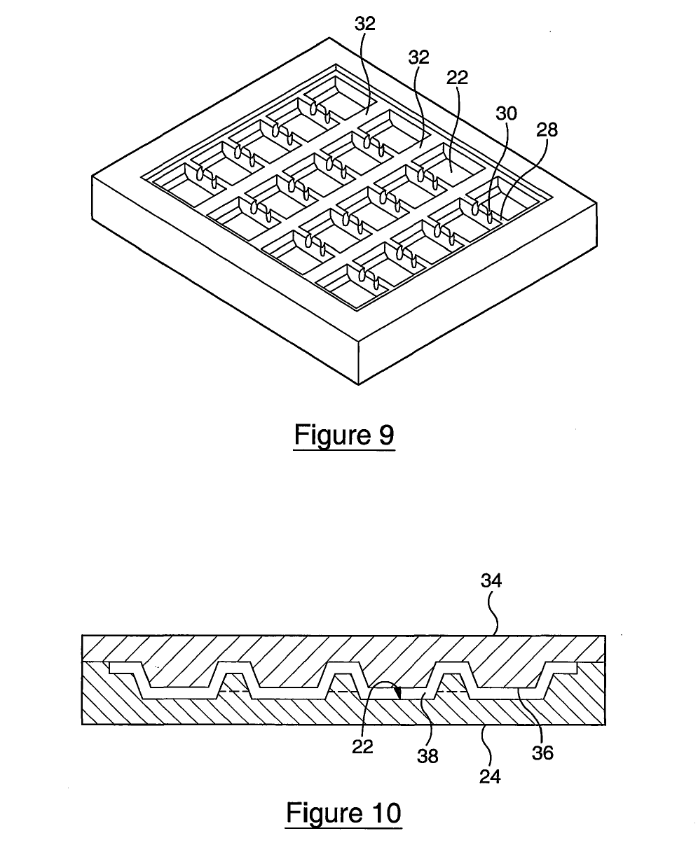

FIG. 9 shows a mould in accordance with the third aspect of the invention for forming a plurality of baked products of FIG. 1;

FIG. 10 shows a mould in accordance with the third aspect of the invention for forming the baked product of FIG. 3;

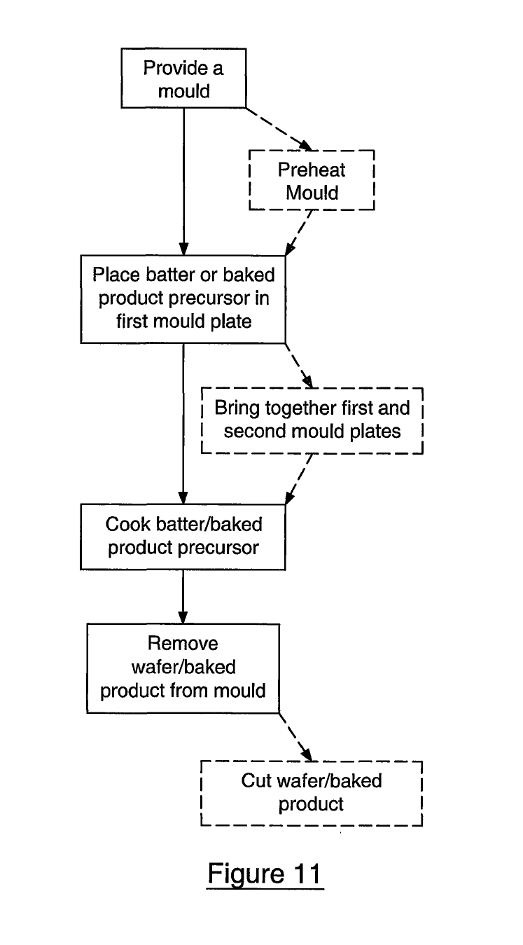

FIG. 11 shows a flow chart of the method in accordance with the forth aspect of the invention;

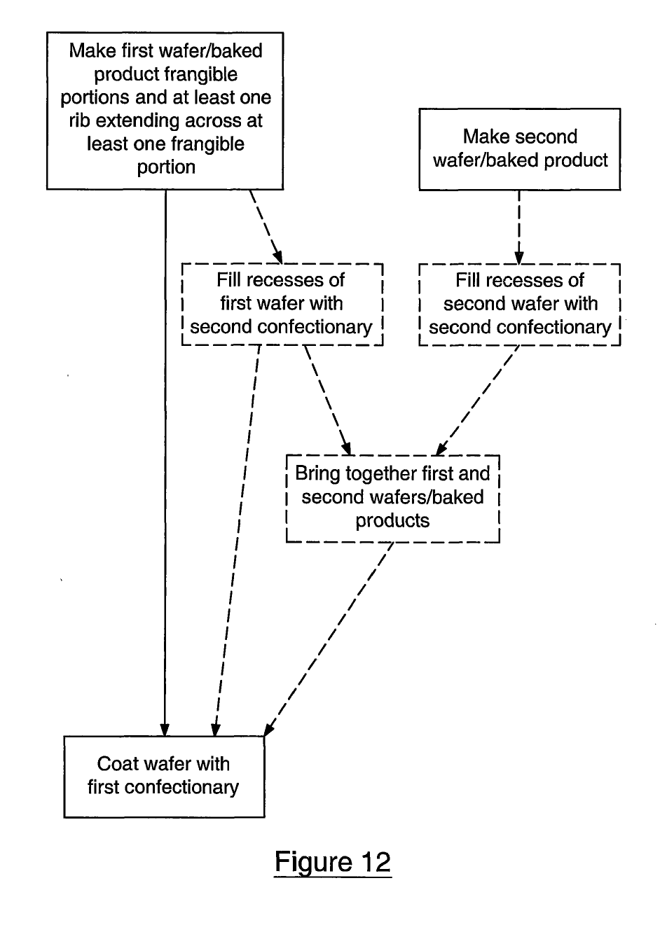

FIG. 12 shows a flow chart of the method in accordance with the fifth aspect of the invention; and

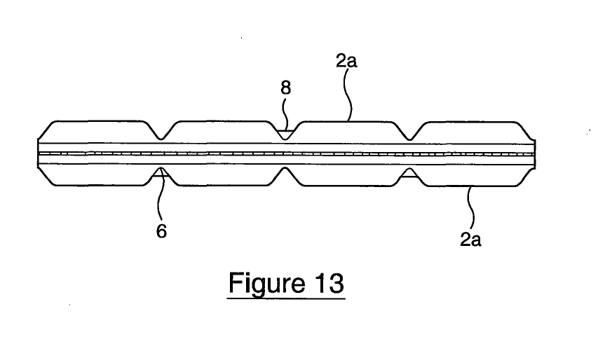

FIG. 13 shows a side view of another baked product in accordance with the invention comprising two baked products sandwiched together

Referring to FIGS. 1 and 2 a baked product 2 is shown. Although described herein as a wafer, by way of example, it will be appreciated that the baked product could be any suitable baked product for which it is desirable to have a portionable bar.

The wafer has a number of product sections 4 arranged in a row, each product section 4 being separated from its neighbouring product section 4 by a frangible portion 6. The frangible portion forms an area of weakness at which the wafer will preferably break when a bending force is exerted on it. As can be seen the product sections 4 have a greater height than the frangible sections 6 and are therefore less likely to snap than the frangible sections 6. The wafer 2 therefore is a product that can be broken into smaller pieces in a predefined way for consumption. The wafer has a wall thickness in the range of 1 mm to 6 mm. Particular embodiments may include the wall thickness being at least 1 mm; at least 1.5 mm; at least 2 mm; at least 2.5 mm; at least 3 mm; or at least 3.5 mm. The thickness may also be no more than 4 mm; no more than 4.5 mm; no more than 5 mm; no more than 5.5 mm; or no more than 6 mm. In a particular arrangement the wall thickness may be in the range of 15 mm to 4.5 mm. The frangible portion and the product section may both have different wall thicknesses, one or both of which may be in the ranges described above. These wall thicknesses may apply to any of the embodiments described herein.

As described above, although the frangible portions assist in the portioning of the bars they do make the products more susceptible to breaking. In a production facility where the products 2 are moved around automatically, breakage of the products prior to packaging introduces a number of problems. In particular packaging and production equipment is designed to be used to operate with the bar of the desired size so broken bars or parts of broken bars can be disruptive in the production line. Any broken bars must be removed prior to packaging and therefore reduce the efficiency of the production facility. Although the removal of product not meeting the required specification in itself does not produce many technical challenges and is common place in food manufacture, having a product which fractures too easily increases waste and, as a result, reduced throughput as a greater percentage of the produced wafer products 2 are scrapped prior to packaging.

The present invention, as embodied in FIGS. 1 and 2, has at least a number of ribs 8, also made of the same product, e.g. wafer or baked product, extending across each of the frangible portions 6. The ribs 8 extend upwardly between the twp adjacent product sections 4 along a curve. A central one of the ribs 8 is substantially in a C shape and a curved rib 8 is located either side of the central rib.

These raised ribs 8 traverse the frangible portions 6 and strengthen the bars in the region of the frangible portions 6 thereby increasing their resistance to snapping. The introduction of these raised ribs 8, as opposed to merely increasing the thickness of the frangible portion 6 has the benefit that while increasing the resistance to unintentional snapping, and therefore increasing the strength of the product 2, the preferred snap line across the remainder of the frangible portion 6 to either side of the raised ribs 8 is maintained, thereby resulting in a clean snap along a particular predefined line.

As can be seen the ribs 8 extend from the frangible portion 6 to a height that is less than the height of the product sections 4. By maintaining this lower height so that the ribs 8 terminate at sloped sides 10 of the product sections 4, as a crack propagates through the wafer under a bending motion the likelihood of the crack propagating across the substantially planar top surface of the product section is reduced, i.e. any sideways propagation is restricted and thus the crack continues to propagate along the frangible section 6. Although this height restriction is not essential to the invention it does result in a bar that has improved crack propagation characteristics compared to a product wherein the ribs 8 extend to the same height as the product sections 4.

Referring to FIGS. 3 and 4, a second embodiment of the invention is shown. It will be appreciated by the skilled person that these figures show the underside of a wafer product 2a, the top surface of which is as described in relation to FIGS. 1 and 2. In this embodiment the lower section of the product sections 4 are each provided with a recess 12 therein. As shown in FIG. 4 the recesses are filled with a fondant creme 14. It will be appreciated however that the recesses can be filled with other suitable confectionery or other food products which could include, without limitation: chocolate, toffee, yogurt, truffle, caramel, liqueurs, syrups, fruit pastes, pralines, mousses, peanut butter, hazelnut chocolate paste, dairy products such as cheese or cheese flavoured pastes, heat flowable cheeses or cheese products or other confectionery or savoury gels or pastes, or any mixture thereof. In some embodiments the filling is selected from praline, chocolate, truffle, nut chocolate paste, a confectionery emulsion, and combinations thereof. The filling may include particulate material such as nut pieces, fruit pieces, mint flavoured chips, chocolate chips, dried herbs and spices, cereal pieces, confectionery pieces, dried fruit and the like, or mixtures thereof. As will be appreciated, filling the recesses increases the strength of the product sections. It will also be appreciated that although shown as being filled in FIG. 4 the product can be left empty.

Referring to FIG. 5 a third embodiment if the invention is shown which comprises two of the wafers 2a described in relation to FIGS. 3 and 4 sandwiched together. The two wafers 2a are held together buy a thin layer of edible foodstuff 16. The edible foodstuff 16 may be the same as the food product 14 used to fill the wafers. As will be appreciated the recesses of the product sections does not have to be filled and could be left empty to produce a product having hollow centres. As can be seen, the two wafers 2, 2a are aligned such that the frangible portions 6 and the ribs 8 are aligned with one another such that when subjected to a bending motion the product will preferentially snap along the frangible portion 6.

It will be appreciated that the product shown in FIG. 5 could also be made using the wafers of FIGS. 1 and 2 which would result in a solid wafer product with a thin layer of edible foodstuff holding them together.

Alternatively, or if there is no filling, the material may be any foodstuff that will maintain the wafers together. The product of FIG. 5, if made with the wafers 2a of FIG. 3 can also have a hollow centre.

Referring now to FIGS. 6a to 6f various other product configurations are shown. FIG. 6a shows a top view of a product similar to that of FIGS. 1 and 2, albeit having different proportions. As can be seen the product sections are more rectangular and elongate. As can be seen this arrangement only has two ribs extending between the product sections and the ribs are straight. FIGS. 6b and 6c show bottom and top views respectively of a product similar to that of FIG. 6a but having a recess in the underside as described in relation to FIG. 3. As can be seen in FIG. 6b a partial cut line 18 is provided along the frangible portion. Such a partial cut line 18 may be made as a cut line part way through the frangible portion or alternatively may be made as an intermittent cut line part or all the way through the frangible portion. The provision of these cut lines 18 further increases the accuracy of crack propagation in the desired place. Although the cut lines 18 may be used with any product they may be particularly beneficial with more brittle products, for example biscuit type products. Referring now to FIG. 6d this shows a product similar to that of FIGS. 1 to 4 but which comprises a rectangular array of product sections 4 as opposed to the linear array shown in FIGS. 1 to 4 the strengthening ribs 8 are provided between the product sections 4 of adjacent rows of the array as well as between adjacent product sections in the same row of the array. FIGS. 6e to 6f depict alternative arrangement of the wafer or baked product. FIG. 6e shows a linear array of a product having circular product sections and FIG. 6f shows a product having a linear array of triangular product sections.

Referring to FIG. 7 a snack product 20 is shown which comprises a wafer of FIG. 5 that is coated with chocolate, although other confectionery or savoury products may be used, for example carob based products or yoghurt containing products.

The wafer may be coated using known techniques, for example by passing the wafer through a curtain of molten chocolate, by dipping the wafer in a bath of molten chocolate or by spray coating. As can be seen the coating conforms to the shape of the exterior of the wafer and the raised portions that give the wafer strength are partially obscured but can be seen after the wafer is coated. It will be appreciated that any of the wafer products described above can be coated in this manner to form a snack product, in particular the snack product may comprise a coating on the wafer of FIG. 1, the filled wafer of FIG. 4, or a wafer having a shape as described in relation to FIGS. 6a-6f.

It will also be appreciated that the coating may substantially fill the recesses between the product sections such that the snack product does not have the appearance of having product sections.

Referring to FIG. 8 a mould for making a wafer or baked product according to FIG. 1 is shown. As can be seen the mould is a negative impression of the wafer of FIG. 1. The mould has a first mould plate 24 having a substantially planar surface 26. A plurality of product section recesses 22 are formed in the planar surface 26 for forming the product sections of the wafer therein. A plurality of raised sections 28 are located between the product section recesses 22 and extend from the base of the product section recesses 22 towards the planar surface 26. These raised sections 28 forming the frangible portions in the wafer or baked product made in the mould. Each raised section 28 has one or more recesses 30 therein that extend into the raised section. The recesses 30 open at either end into the product section recesses 22. The recesses 30 form the raised strengthening portions in the product made in the mould. To make the wafer a batter is poured into the mould and is heated to cook the batter to form a wafer. The mould may be preheated prior to placing the batter in the mould. Alternatively an uncooked baked product mixture may be placed in the mould and heated therein to cook it.

Referring to FIG. 9 a mould for producing multiple wafers is shown. The mould is substantially the same as that shown in FIG. 8, except in so far as it comprises a plurality of rows of product section recesses 22 and the raised sections 28, between the product section recesses 22 of a row, have recesses 30 therein for forming the raised sections in the moulded product.

A plurality of second raised sections 32 are formed between the adjacent rows of product section recesses 22. These second raised sections 32 do not have any further recesses therein and form a small flat area of wafer or baked product separating the adjacent rows of product section in the moulded product. Rows of product sections of wafer or baked product can then be separated from one another along the small flat areas made by the raised sections 32 so that the multiple wafers as shown in FIG. 1 can be produced from a single mould. The wafers or baked products may be separated from one another by cutting the composite moulded wafer along the lines formed by the raised sections 32. The wafer may beneficially be cut along these lines while still in the mould after the product therein has been cooked, as it will be well supported, or may be cut after it has been removed from the mould.

Referring to FIG. 10, a cross section through a further mould of the invention is shown. The mould has a first mould plate 24 which may be as described in relation to FIG. 8 or 9, and a second mould plate 34. The second mould plate 24 has a plurality of protrusions 36 that align with the product section recessed 22 so as to form a gap 38 therebetween. In manufacture the batter or uncooked baked product is placed in the first mould plate 24 and the second mould plate is then brought into place and the mould heated so that the wafer or baked product is formed in the gap between the moulds plates. In this manner a wafer or baked product as shown in FIG. 2 may be made. It will be appreciated that the two mould plated may be used with the mould plate shown in FIG. 9 and if so the wafer may be cut as described above. It will equally be appreciated that other shaped second mould plates 34 may be used which may have n protrusions 36, or may have protrusions of different sizes or shapes to give a different shaped recess in the wafer or baked product.

Referring to FIG. 11 a flow diagram of a method of making a wafer or baked product as shown in FIG. 1 is shown. The method comprises a first step of providing a mould as described above having a first mould plate. A batter or baked product precursor, for example an uncooked baked product mixture, is then placed in the first mould plate which is heated to cook the batter or baked product precursor. Finally the wafer or baked product is removed from the mould. The method may also include the step of providing a second mould plate and, after placing the batter or baked product precursor in the said first mould plate, bringing the first and second mould plates together to form a cavity containing said batter or baked product precursor therebetween. The product is then cooked in the mould as described above.

It will be appreciated that cooking the product in the mould requires heating the mould. The mould may optionally be pre-heated to decrease the processing time and the product removed from the mould without cooling so as to decrease baking time and increase throughput.

In one embodiment of the method the first mould plate is a mould plate as described in relation to FIG. 9. The method may further comprise the step of, after removal of said plurality wafer or baked product from said mould, cutting the wafer along the lines formed by said second plurality of raised sections to divide said wafer into a plurality of wafer or baked products. It will be appreciated that this cutting step may take place before the product is removed from the mould.

Referring to FIG. 12 a flow diagram of making an article of confectionery is shown. The method comprises a first step of making at least one wafer or baked product as described above, and a further step of coating the at least one wafer or baked product with a first confectionery product, which may be chocolate.

The method may comprise additional steps of making a further one wafer or baked product and bringing the two wafer of baked products together in alignment prior to the step of coating the wafer or baked product with a confectionery product.

Where the wafers have a recess in as shown in FIG. 2 the method may include the an additional step of filling the recesses in the product sections with a foodstuff, which maybe a second confectionery product, prior to coating with the first confectionery product, and where two wafers are used to make the confectionery product the recesses are filled prior to the step of bringing the two wafer or baked products together. The confectionery products may be any suitable confectionery products and may be the same or may be different from the foodstuff in the cavities of the wafer or baked product.

Referring to FIG. 13 an alternative baked product to that shown in FIG. 5 is shown. In this embodiment the ribs 8 that bridge the frangible portions 6 are provided on alternate frangible portions of the two baked products 2a such that when the two baked products are brought together as shown a frangible portion of one baked product not having a rib associated therewith is immediately adjacent or overlying a frangible portion of the other baked product that does have a rib associated therewith. In this manner at each frangible section of the product formed by two overlying frangible portions 6 at least one rib is present on one of the two overlying baked products.

As will be appreciated the different aspect of the invention are an interrelated product and its manufacture and accordingly, even if not specifically cross referenced herein, the skilled person will appreciate that features described in relation to one aspect of the invention apply equally to the other aspects of the invention.

1. A snack product comprising:
a baked product comprising a plurality of product sections, adjacent product sections mutually separated by a frangible portion, said frangible portions including at last one rib extending across at least one of said frangible portions and interconnecting said adjacent product sections, and,
a further baked product, the baked product and the further baked product joined to one another along their length.

2-4. (canceled)

5. A snack product according to claim 1 wherein the product sections of the baked product each have a first height and the or each frangible portion has a second height, less than that of the product sections, thereby forming recesses therebetween.

6. A snack product according to claim 5 wherein the one or more ribs of the baked product bridges at least one of said recesses.

7. A snack product according to claim 1 wherein the product sections of the baked product have recesses in at least one face thereof.

8. (canceled)

9. A snack product according to claim 1, additional comprising a coating of a first edible substance thereon.

10-11. (canceled)

12. A snack product according to claim 1 wherein the further baked product comprises plurality of product sections, adjacent product sections mutually separated by a frangible portion, said frangible portions including at last one rib extending across at least one of said frangible portions and interconnecting said adjacent product sections.

13. A snack product according to claim 12 wherein the product sections of the baked product and the further baked product both have recesses therein.

14. A snack product according to claim 13 wherein the recesses in the product sections of one of the baked products are deeper than the recesses in the product sections of the other baked product.

15. (canceled)

16. A snack product according to claim 14 wherein the ribs are on the baked product having recesses of a lesser depth.

17. (canceled)

18. A snack product according to claim 12; wherein:
each baked product comprises three or more product sections;
the ribs on each of the first and second baked product are only provided bridging alternative frangible sections of each said first and second baked product;
the ribs on the first and second baked product are offset from one another such that a frangible portion of the first baked product not provided with ribs is positioned overlying a frangible portion of the second baked product having ribs, and
a coating of a first edible material is provided thereon.

19. A snack product according to claim 12 wherein a second edible substance is provided in each recess.

20-25. (canceled)

26. A snack product according to claim 9 wherein the first edible material substantially fills the frangible portions such that substantially no recesses are present between the product sections.

27. A mould for producing a baked product comprising a plurality of product sections, adjacent product sections mutually separated by a frangible portion, at least one said frangible portions including at last one rib extending across said frangible portions and interconnecting said adjacent product sections, the mould comprising:
a first mould plate having a substantially planar surface;
a plurality of product section recesses in said surface for forming said product sections;
a first plurality of raised sections located between said product section recesses and extending from the base of the product section recesses towards the planar surface, said first plurality of raised sections for forming said frangible portions; and
one or more rib forming recesses in at least one of said first plurality of raised sections; said one or more rib forming recesses for forming said ribs,
wherein the rib forming recesses have a lesser depth than the first plurality of recesses.

28. A mould according to claim 27 wherein said one or more rib forming recesses are provided in each of said first plurality of raised sections.

29-31. (canceled)

32. A mould according to claim 27 further comprising a second mould plate that aligns with said first mould plate to form enclosed mould cavities therebetween.

33. A mould according claim to claim 27 wherein said second mould plate has raised sections thereon that align with and pass into the product section recesses in the first mould plate.

34. A method of making a snack product according to claim 9, the method comprising:
providing a mould comprising a first mould plate having a substantially planar surface; a plurality of product section recesses in said surface for forming product sections, a first plurality of raised sections between said product sections extending from the base of the recesses towards the planar surface, said recesses for forming said frangible portions; and a plurality of rib forming recesses in at least one said first raised sections; said rib forming recesses for forming said ribs;
placing a batter or baked product precursor in said mould;
heating said mould to cook said batter or baked product precursor;
removing said at least one baked product from said mould,
making a further baked product, and
bringing said baked products together in alignment before coating said at least two baked product with a first edible substance.

35-49. (canceled)
